(19) United States
(12) Patent Application Publication
(10) Pub. No.: US 2018/0286621 A1
(43) Pub. Date: Oct. 4, 2018

(54) SEMICONDUCTOR-FREE VACUUM FIELD EFFECT TRANSISTOR FABRICATION AND 3D VACUUM FIELD EFFECT TRANSISTOR ARRAYS

(71) Applicant: Palo Alto Research Center Incorporated, Palo Alto, CA (US)

(72) Inventors: DAVID K. BIEGELSEN, PORTOLA VALLEY, CA (US); JENGPING LU, FREMONT, CA (US)

(21) Appl. No.: 15/476,737

(22) Filed: Mar. 31, 2017

(51) Int. Cl. H01J 9/02; H01J 21/10; H01J 19/02

(52) U.S. Cl. CPC H01J 9/02; H01J 19/02; H01J 21/10

(57) ABSTRACT

A vacuum field-emission-transistor device, a drain comprised of either a metal or a semimetal material, a gate arranged adjacent to, but separated from, the drain, a source comprised of either a metal or a semimetal material adjacent to, but separated from the metal gate, and a void through the metal drain and the metal gate to expose the drain, wherein the distance between the drain and the source is shorter than a mean free path distance of electrons in air.

### TECHNICAL FIELD

This disclosure relates to vacuum field effect transistors, more particularly to semiconductor-free vacuum field effect transistors.

### BACKGROUND

Moore's law refers to a statement credited to Intel co-founder Gordon Moore in which he observed that the number of transistors per square inch on integrated circuits has doubled every year since their invention. The use of full three-dimensional integration may allow extension of this relationship. Three-dimensional (3D) integration typically involves stacking of semiconductor devices or dies and connecting them vertically through vias.

Current approaches typically involve many layers of heteroepitaxial growth of semiconductors. However, this generally results in rapidly deteriorating quality. Growing multiple heteroepitaxial semiconductor layers often results in semiconductor defects due to poor growth. Other approaches include laser recrystallization and amorphous silicon layers and have suffered from the same issues. In addition, the devices also suffer from poor heat extraction, causing further failures. Each of these issues has limited the number of layers to just a few.

To develop better 3D integration, one can use vacuum field effect transistors (vFET). Field emission devices normally require a hard vacuum for operation. However, if the distance between emitter and collector are smaller than the electron mean free path in air or other gases, a device can operate in such an ambient as if it were a vacuum. Typically, vFETs that operate in air or controlled gases use a fabrication process relying on semiconductors and use a planar electronics configuration. This would affect their manufacturability when applied to 3D monolithic integration. It is possible to replace the semiconductor channels of transistors with semiconductor-free vacuum field-effect transistors (vFETs) and use refractory metal or semimetal layers and insulators to remove these problems.

### SUMMARY

A first embodiment consists of a vacuum field-emission-transistor device having a drain comprised of either a metal or a semimetal material, a gate arranged adjacent to, but separated from, the drain, a source comprised of either a metal or a semimetal material adjacent to, but separated from the metal gate, and a void through the metal drain and the metal gate to expose the drain, wherein the distance between the drain and the source is shorter than a mean free path distance of electrons in air.

A second embodiment consists of a device having a first planar array of vacuum field-effect transistors, where in each transistor has a drain formed from regions of metal or semimetal on a first dielectric film, a gate formed on a second dielectric film arranged on the first dielectric film, a source from regions of metal or semimetal on a third dielectric film arranged on the second dielectric film, and a void formed through the second and third dielectric films to expose the drain and form a channel between the source and the drain; a second planar array of vacuum field effect transistors arranged in a vertical stack with the first planar array of vacuum field effect transistors, and an interposer film between the first and second arrays of planar transistors.

Another embodiment consists of a method of manufacturing a vacuum field-effect transistor. The method forms a first metal layer on an insulating substrate, patterning the first metal layer to form drains, depositing a first dielectric layer on the drains, depositing a second metal layer on the first dielectric layer, patterning the second metal layer to form gates, depositing a second dielectric on the gates, depositing a third metal layer on the second dielectric, patterning the third metal layer to form sources such that the sources are arranged to form a stack with the drains and gates, and etching holes through the sources and the gates to expose the drains to form a first planar array of vacuum field-effect transistors.

### BRIEF DESCRIPTION OF THE DRAWINGS

FIG. 1 shows an embodiment of a metallic vFET device.

FIG. 2 shows an embodiment of a three sheet metallic vFET device.

FIG. 3 shows an embodiment of a single layer of asymmetric vFET devices.

FIG. 4 shows an embodiment of a multi-layer stack of vFETs.

FIG. 5 shows an embodiment of a multi-layer stack of vFETS in a processing position.

FIG. 6 shows an embodiment of a first planar array of vFETs with an interposer.

FIG. 7 shows an embodiment of a stack of planar arrays of vFETs.

FIG. 8 shows an embodiment of a roll to roll processing system.

### DETAILED DESCRIPTION OF THE EMBODIMENTS

This discussion relates to vacuum field-effect transistors, or vFETs. A field-effect transistor, as used here, consists of a device having a semiconductor-free channel to carry current. A gate electric field controls the electron emission from the source electrode and thus the current in the channel that flows from the source electrode to the drain electrode. In vacuum tube terminology, the term source is analogous to a cathode, and the term drain is analogous to an anode. Since the below discussion involves FETs, the terms source and drain will be used.

A ‘vacuum’ FET employs some of the principles of vacuum tube technology, in which a vacuum replaces the semiconductor channel. The term ‘vacuum’ is somewhat of a misnomer, as the channel can be formed in ambient air because the operating voltage is less than the ionization voltage of air. Almost no ions are created and attracted to electrodes, and for short source-drain gaps, less than 100 nanometers, the mean free paths of electrons in air is longer than the gap. The result is that few collisions, elastic or inelastic, occur.

One possible architecture for vFETs has a lateral layout, with the source and drain arranged laterally to each other and the channel between them. However, difficulties arise in controllably fabricating the short gaps and small radius features, making the lateral vFET undesirable. It is possible to have a vertical architecture, and some of these have been created, but they generally consist of semiconductor materials. As mentioned previously, semiconductor materials can have defects due to poor growth and suffer from poor heat extraction.

The embodiments here consist of vertical vFETs using only metals or semimetals and dielectrics with no semiconductor compounds. The term ‘semimetal’ is used here interchangeably with ‘metalloids’ rather than compounds of a metal and a non-metal, which may also be referred to as semimetals. The compounds defined here as semimetals include the more commonly recognized semimetals including boron, silicon, germanium, arsenic, antimony, and tellurium; as well as carbon, aluminum, selenium, polonium, and astatine.

Some of the embodiments include vertically stacked layers of vertical vFETs. The below figures show devices using metals or semimetals layers such as graphene, copper, and/or aluminum, as examples. Aluminum has a lower melting temperature, but its native oxide may assist in forming the thin dielectric layers, discussed below. The insulator layers could be silicon dioxide or graphene oxide or any other thin, preferably high temperature, high breakdown field, low defect dielectrics. For purposes of this discussion, a high temperature dielectric includes any dielectric with melting temperature greater than 600 C. The gate enhances or diminishes field emission from the source by lowering or raising the tunnel barrier and by accumulating or depleting the 2d electron or hole gas in the source (cathode) near the source/vacuum edge of the pit, also referred to as a void. Opposite charges may accumulate away from the pit or void. Space charge, which tends to screen the source-drain field, limits the source/drain (or cathode/anode) current.

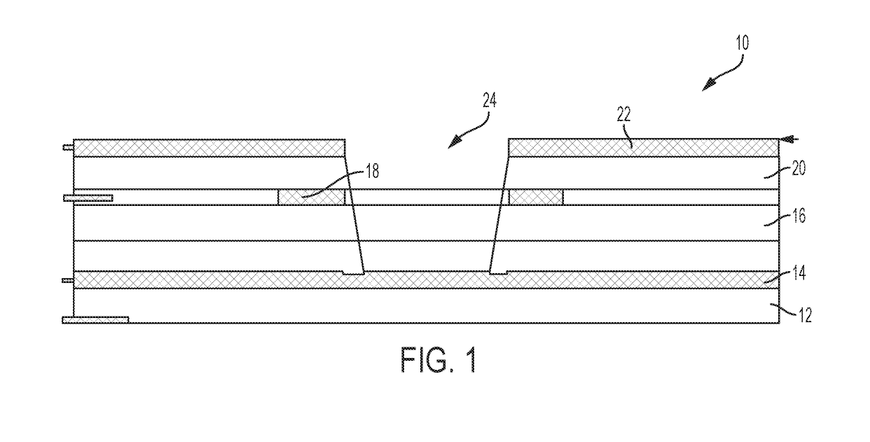

FIG. 1 shows one such device 10. The device 10 consists of an insulator 12, having a layer 14 of metal or semimetal on it to act as the drain. In one embodiment, the insulator is graphene oxide and the drain layer is graphene. Another layer of dielectric insulator 16, such as graphene oxide separates the drain 14 from the gate layer. The gate layer consists of patterned metal or semimetal regions, such as graphene, 18, surrounded laterally by graphene oxide or other insulating material in the layer. The gate layer has another layer of insulator 20 on it, to separate the gate layer from the source layer 22.

The channel forms between the source 22 to the drain 14 through a void 24. By controlling the distance between the source and the drain, the device can use the ‘vacuum’ to transport the electron flow. The source-gate separation should generally be less than half the gate-drain separation. The gate controls the field that in turn controls the emission.

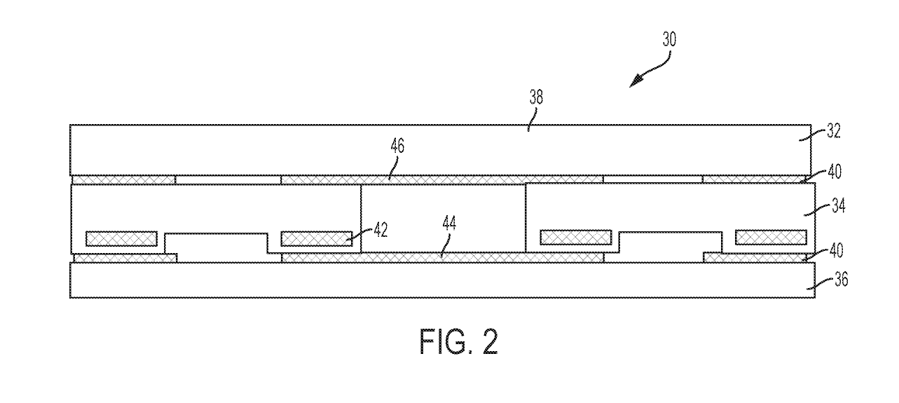

FIG. 2 shows another possibility. The device layer consists of three sheets, 32, 34 and 36. Sheets 32 and 36 are thin dielectric films with laterally patterned sources and drains and connect lines such as 40, using a non-oxidizing metal such as gold, platinum or copper, or a semi-metal such a graphene. These connect lines form the source 46 and the drain 48. The middle sheet 34 consists of a dielectric layer with a patterned metal semi-metal that forms a self-limiting or parametrically-controlled dielectric thickness, such as aluminum or silicon does in air, water vapor or other chemical environments.

The manufacturing process etches holes through the sheet at the centers of the gate regions and the gate metal is oxidized or otherwise reacted to form a thin insulating barrier. An added feature of the hole formation through just the source and gate, stopping at the drain is that the drain has a much larger area than the peripheral areas of the source. One can raise the space charge limitation on the source-drain current substantially.

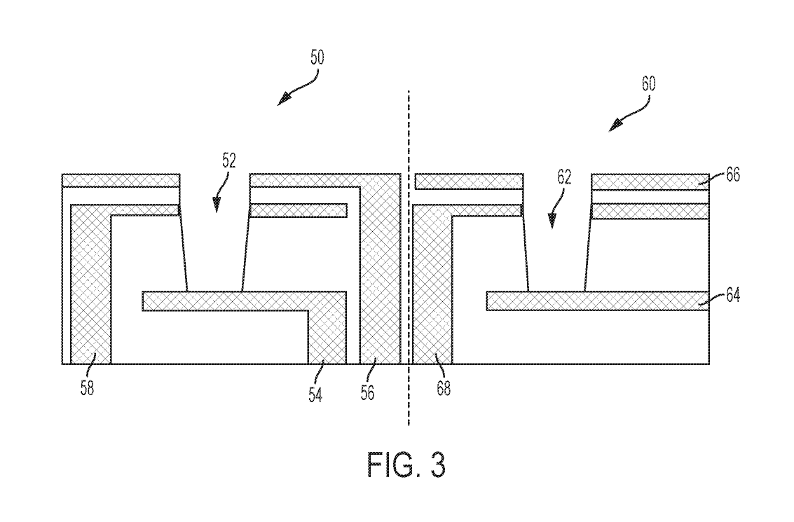

FIG. 3 shows an array of devices such as 50 and 60 in a planar stack. In one embodiment, the drains 54 and 64 may be held at a common voltage. The gates 58 and 68 are held at various positive voltages, causing accumulation or depletion of electrons to modulate emission from their respective sources 56 and 66 through the vacuum channels 52 and 62.

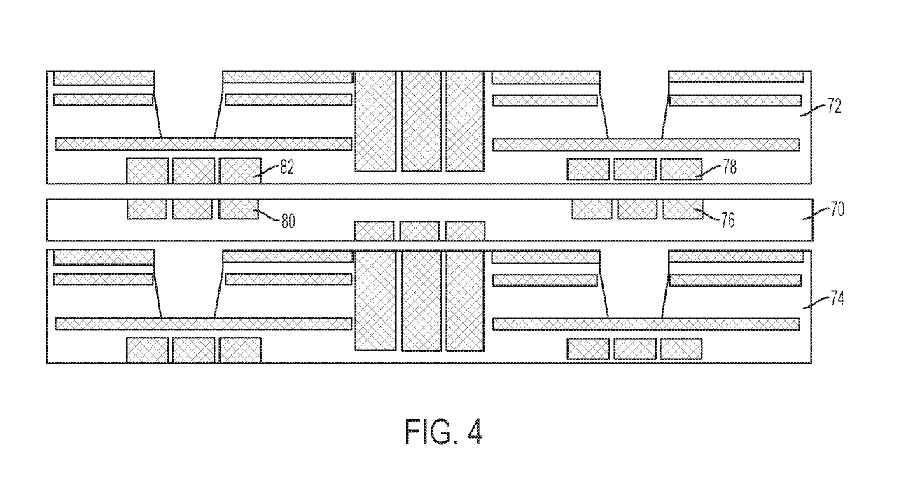

FIG. 4 shows an interposer layer 70, between a first planar array of vFETs 72 and a second planar array of vFETS 74. The interposer layer 70 may include sets of electrical connections such as 76 and 80 that connect to the devices in each planar array through connections such as 78 and 82.

One can modify the work function of the electrodes to enhance emission. A chemical or physical coating can accomplish this. The low voltages of the nano-scale devices should lead to greatly reduced damage and enhanced lifetimes of the coatings relative to ordinary field emission devices. One should note that the vertical dimensions are the only dimensions that must have nano-scale and uniformity. The lateral features may have macroscopic lateral feature sizes.

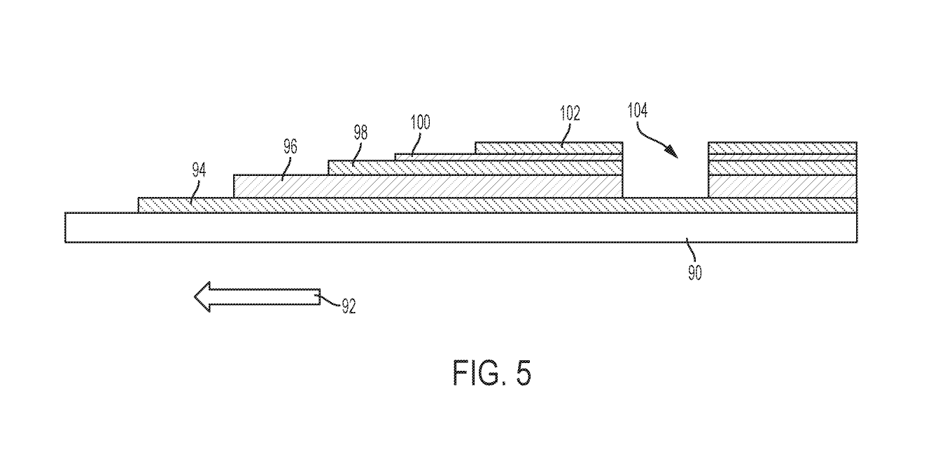

FIG. 5 shows an example of a three dimensionally fabricated structure manufactured by one of either a roll to roll or sequential planar process that moves in the direction 92. FIG. 5 shows a single layer and FIG. 7 shows a second layer stacked above with an interposer layer connecting devices within and between layers. An insulating substrate 90 receives a metal layer 94, such as tungsten, which is patterned to form drains. Then dielectric layer 96, such as silica is deposited using atomic layer deposition (ALD) or chemical reaction, with a controlled thickness of −40 nm. Then gate layer 98 is deposited and patterned before dielectric layer 100 is deposited to a controlled thickness of 10-20 nm. Next, metal layer 102 is deposited and patterned. Finally holes 104 are etched through the metal and dielectric layers stopping at the drain layer.

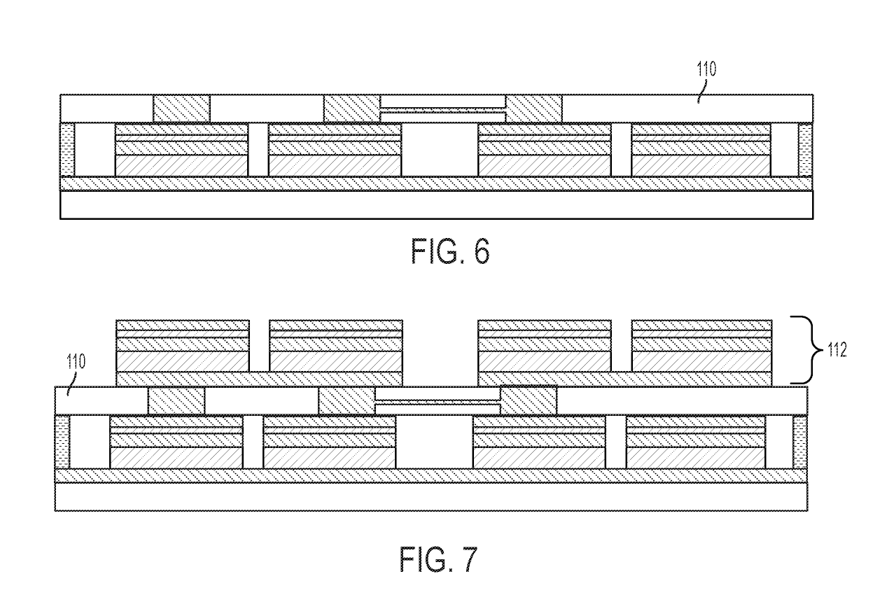

FIG. 6 shows an interposer layer 110 formed, for example, as a thin glass layer with through wafer vias is then aligned and bonded to the vFET layer. The vFET fabrication process is then repeated to create a 3d integrated circuit, such as those shown in FIG. 7. A second vFET planar array 112 is formed on the interposer 110. In another embodiment, the interposer is not used. Instead, the layer 102 is used as the metal layer for the second layer, analogous to layer 94 for the first layer.

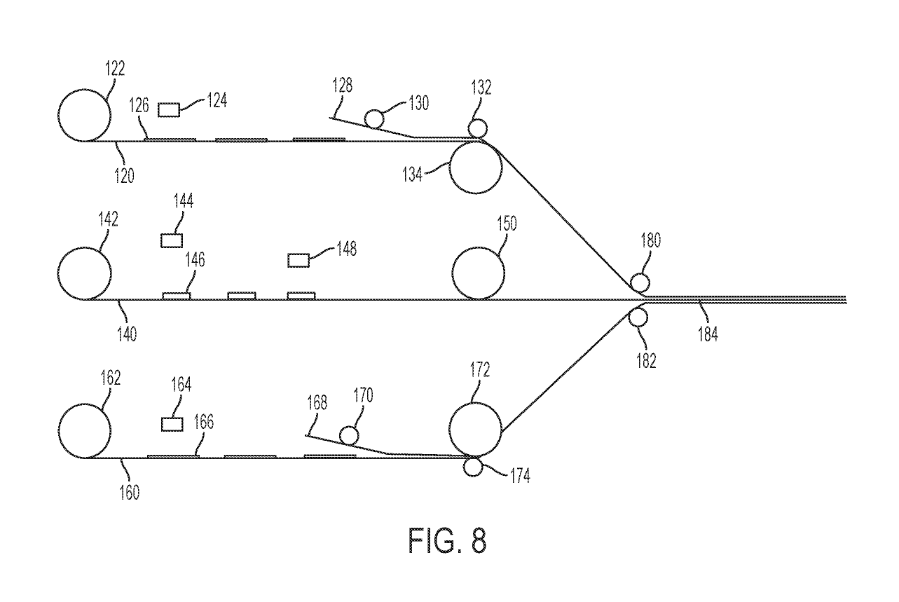

In another instantiation a roll to roll process is used to fabricate the layers and build up the 3d structure. FIG. 8 shows an example of a possible roll to roll process for fabrication of a sheet of devices. On a substrate metal is first deposited in a patterned manner for example by a printing means such as ink jetting, then covered with a dielectric deposition. Next the gate metal is deposited in a patterned manner and subsequently covered with a controlled dielectric deposition. Finally, the source layer is deposited in a patterned manner before pits are etched using ion beams, laser ablation, or other means, stopping preferentially at the drain layer. An interposer layer is then bonded, preferably in vacuum, and the process is continued to form the 3d structure the three layers discussed above.

Many variations on these processes are possible, the below discussion is merely one example of such a process. In this embodiment, three rolls of dielectric merge into a final composite film. A roller 122 directs a first roll 120 of dielectric under a print head 124 that solution prints the metal or semimetal regions 126 on the dielectric to form the source regions. Once printed, the source film may be then covered by a dielectric film 128 from a directional roller 130. These two films then merge at the nip between rollers 132 and 134. The dielectric under the drain contact regions may become part of the gate dielectric.

A second dielectric film 140 from roller 142 also receives printed metal or semimetal regions 146 from print head 144 that will eventually form the gate regions. As will be discussed in more detail regarding the composite film 184, the second print head 148 may deposit a material that can be etched to form the pits on the gate film 140. The patterned film then eventually merges with the film from 132/134 at the roller 180 and 182.

A third film 160, off roller 162, receives patterned metal or semimetal regions such as 166 from the print head 164 to form the drain regions. A covering film such as 168 may cover the patterned region and merge from roller 170. These films are merged at the nip between rollers 174 and 172. As mentioned above, all three of these films then merge at the nip between rollers 180 and 182. The resulting composite film 184 may then be treated to etch the extra material laid down as part of the gate region printing to form the voids.

In another embodiment, the drain film 160 and the gate film 140 may be merged prior to the addition of the source film 120, with the etching or material removal over the gate region occurring prior to the addition of the source film. Alternatively, the holes could be formed in the gate film prior to the merging of the films.

In this manner, a three-dimensional array of metal or semimetal vFETS can be provided having much better manufacturability and no defects from poor semiconductor heteroepitaxial growth, as there are no semiconductors involved that undergo heteroepitaxial growth.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A vacuum field-emission-transistor device, comprising:
a drain electrode comprised of either a metal or a semimetal material;
a metal gate arranged adjacent to, but separated from, the drain;
a source electrode comprised of either a metal or a semimetal material adjacent to, but separated from the metal gate; and
a void through just the source and the metal gate to expose the drain, wherein the void is open to ambient atmosphere,
wherein a distance between the drain and the source is shorter than a mean free path distance of electrons in ambient air and the distance between the metal gate and the source is less than half the distance between the metal gate and the drain.

2. The device of claim 1, further comprising an array of devices arranged adjacent to each other in a planar array.

3. The device of claim 2, wherein the drain of each device in the array of devices is held at a common voltage.

4. The device of claim 1, wherein the source and the drain are one of the group consisting of: graphene, copper, or gold.

5. The device of claim 1, wherein the gate is a self-limited oxidizing metal or semimetal.

6. The device of claim 1, wherein the gate is one of either aluminum or silicon.

7. The device of claim 1, wherein the source and drain have a coating to enhance their work function.

8. A device, comprising:
a first planar array of vacuum field-effect transistors, each transistor comprising:
a drain electrode formed from regions of metal or semimetal on a first dielectric film;
a gate formed on a second dielectric film arranged on the first dielectric film;
a source electrode formed from regions of metal or semimetal on a third dielectric film arranged on the second dielectric film; and
a void formed through the gate, source, and the second and the third dielectric films to expose the drain and form a channel between the source and the drain, wherein a distance between the drain and the source is shorter than a mean free path distance of electrons in air, the distance between the gate and the source is less than half the distance between the gate and the drain, and the channel is open to ambient atmosphere; and
a second planar array of vacuum field effect transistors arranged in a vertical stack with the first planar array of vacuum field effect transistors.

9. The device of claim 8, further comprising an interposer film between the first and second planar arrays.

10. The device of claim 9, wherein the interposer film includes connection regions to make electrical connections to transistors in at least one of the first and second planar arrays.

11. A method of manufacturing a vacuum field-effect transistor, comprising:
forming a first metal layer on an insulating substrate;
patterning the first metal layer to form drain electrodes;
depositing a first dielectric layer on the drains;
depositing a second metal layer on the first dielectric layer;
patterning the second metal layer to form gates;
depositing a second dielectric on the gates;
depositing a third metal layer on the second dielectric;
patterning the third metal layer to form source electrodes such that the source electrodes are arranged to form a stack with the drain electrodes and gates, wherein a distance between the drain electrode and the source electrode is shorter than a mean free path distance of electrons in air and the distance between the gate and the source is less than half the distance between the metal gate and the drain; and
etching holes through the just sources and the gates to expose the drain electrode to ambient atmosphere to form a first planar array of vacuum field-effect transistors.

12. The method of claim 11, wherein the first metal layer comprises tungsten.

13. The method of claim 11, wherein the first dielectric comprises silica.

14. The method of claim 11, wherein depositing the first dielectric comprises using one of either atomic layer deposition or a chemical reaction.

15. The method of claim 11, wherein the first dielectric has a thickness of 40 nanometers.

16. The method of claim 11, wherein the second dielectric has a thickness in the range of 10 to 20 nanometers.

17. The method of claim 11, further comprising:
forming a second planar array of vacuum field effect transistors on the first planar array of vacuum field effect transistors.

18. The method of claim 17, further comprising placing an interposer layer on the first planar array of vacuum field effect transistors and forming the second planar array of vacuum field effect transistors on the interposer.

19. The method of claim 18, wherein the interposer comprises a glass layer.
